(19) United States
(12) Patent Application Publication
(10) Pub. No.: US 2026/0203306 A1
(43) Pub. Date: Jul. 16, 2026

(54) SYSTEMS AND METHODS FOR VERIFYING RELEVANCE OF INFORMATION BEING ADDED TO A KNOWLEDGE BASE

(71) Applicant: Verizon Patent and Licensing Inc., Basking Ridge, NJ (US)

(72) Inventors: Sutap CHATTERJEE, Tampa, FL (US); Bharadwaj PRABHALA, Wesley Chapel, FL (US); Viswas PATNALA, Wesley Chapel, FL (US); Rahul APPANA, Wylie, TX (US); Raju SHARMA, Raleigh, NC (US)

(73) Assignee: Verizon Patent and Licensing Inc., Basking Ridge, NJ (US)

(21) Appl. No.: 19/020,130

(22) Filed: Jan. 14, 2025

(51) Int. Cl. G06F 16/28; G06F 16/2457

(52) U.S. Cl. CPC G06F 16/283; G06F 16/24575

(57) ABSTRACT

A device may receive a document, and may divide the document into multiple chunks using a chunking model. The device may embed the chunks into a multi-dimensional vector space to generate vector representations of the chunks. The device may compare the vector representations of the chunks with existing vector representations of existing knowledge elements in a knowledge base using cosine similarity to determine relevance scores for the chunks, and may determine a final score for the document based on the relevance scores of the chunks. The device may selectively store the document in the knowledge base based on the final score satisfying a threshold, or flag the document for review based on the final score failing to satisfy the threshold.

### BACKGROUND

In the field of artificial intelligence (AI), specifically within the context of generative AI systems, large language models (LLMs) have become a cornerstone for various enterprise applications, powering everything from customer service bots to internal knowledge management tools.

### BRIEF DESCRIPTION OF THE DRAWINGS

FIGS. 1A-1G are diagrams of an example associated with verifying relevance of information being added to a knowledge base.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for verifying relevance of information being added to a knowledge base.

### DETAILED DESCRIPTION OF EXAMPLE EMBODIMENTS

The following detailed description of example implementations refers to the accompanying drawings. The same reference numbers in different drawings may identify the same or similar elements.

LLMs, while remarkably versatile, may be trained on vast, generic datasets that capture a broad spectrum of knowledge, much of which is sourced from data published on the Internet. However, enterprises often require that their LLMs operate with a narrower focus. Such enterprises may utilize an enterprise knowledge base that is tailored to a specific industry and operational context when utilizing LLMs at the enterprise level The challenge lies in integrating this specialized knowledge with LLMs in a manner that maintains relevance and accuracy.

Maintaining the integrity and relevance of a knowledge base may be complicated. Currently, there are two methods for working with LLMs to suit enterprise-specific requirements. A prompt context stuffing method is effective, but is not scalable and is limited by a prompt engineer's awareness and inclusion of all necessary contextual information from various sources. Consequently, this could introduce bias into the LLM results due to reliance on potentially incomplete knowledge. A retrieval augmented generation (RAG) method indexes enterprise knowledge and uses the indexes to provide contextually relevant responses to LLM queries. The creation and maintenance of RAG indexes typically involve complex semantic analysis through natural language processing techniques. While indexing at multiple levels can enhance performance and accuracy, it also should ensure that the indexed knowledge elements are truly reflective of the enterprise's domain-specific information. With a continuous stream of new knowledge elements being added to the knowledge base, there is an inherent risk of introducing inaccuracies or irrelevant information, potentially compromising the integrity of the knowledge base.

Thus, current techniques for storing information in a knowledge base for an LLM consume computing resources (e.g., processing resources, memory resources, communication resources, and/or the like), networking resources, and/or other resources associated with failing to ensure that the knowledge base remains accurate and free from contamination by irrelevant or incorrect information, generating incorrect LLM responses based on a corrupted knowledge base, making incorrect decisions within the enterprise context based on the incorrect LLM responses, and/or the like.

Some implementations described herein provide a validation system that verifies relevance of information being added to a knowledge base. For example, the validation system may receive a document, and may divide the document into multiple chunks using a chunking model. The validation system may embed the chunks into a multi-dimensional vector space to generate vector representations of the chunks. The validation system may compare the vector representations of the chunks with existing vector representations of existing knowledge elements in a knowledge base to determine relevance scores for the chunks, and may determine a final score for the document based on the relevance scores of the chunks. The validation system may selectively store the document in the knowledge base based on the final score satisfying a threshold, or flag the document for review based on the final score failing to satisfy the threshold.

In this way, the validation system verifies relevance of information being added to a knowledge base. For example, the validation system may receive a document potentially to be added to a knowledge base utilized by an LLM, and may process the document, with a chunking model, to divide the document into chunks. The validation system may process the chunks, with a machine learning model, to generate vectors representative of the chunks, and may receive knowledge base vectors from the knowledge base. The validation system may calculate similarities between the vectors and the knowledge base vectors, and may determine whether the similarities satisfy an acceptance threshold. The validation system may add the document to the knowledge base based on determining that the similarities satisfy the acceptance threshold, or may process the chunks, with the LLM and based on determining that the similarities fail to satisfy the acceptance threshold, to determine relevance scores for the chunks. The validation system may calculate a final score based on the relevance scores, and may determine whether the final score satisfies a threshold. The validation system may discard the document based on determining that the final score fails to satisfy the threshold, or may add the document to the knowledge base based on determining that the final score satisfies the threshold.

Thus, the validation system may conserve computing resources, networking resources, and/or other resources that would have otherwise been consumed by failing to ensure that the knowledge base remains accurate and free from contamination by irrelevant or incorrect information, generating incorrect LLM responses based on a corrupted knowledge base, making incorrect decisions within the enterprise context based on the incorrect LLM responses, and/or the like.

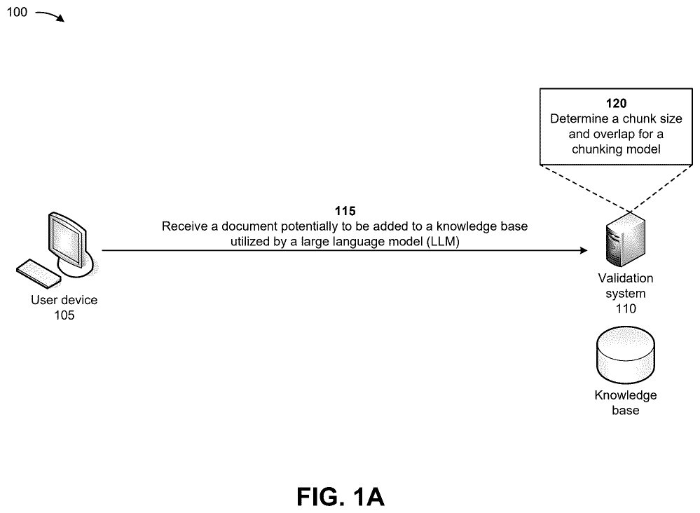

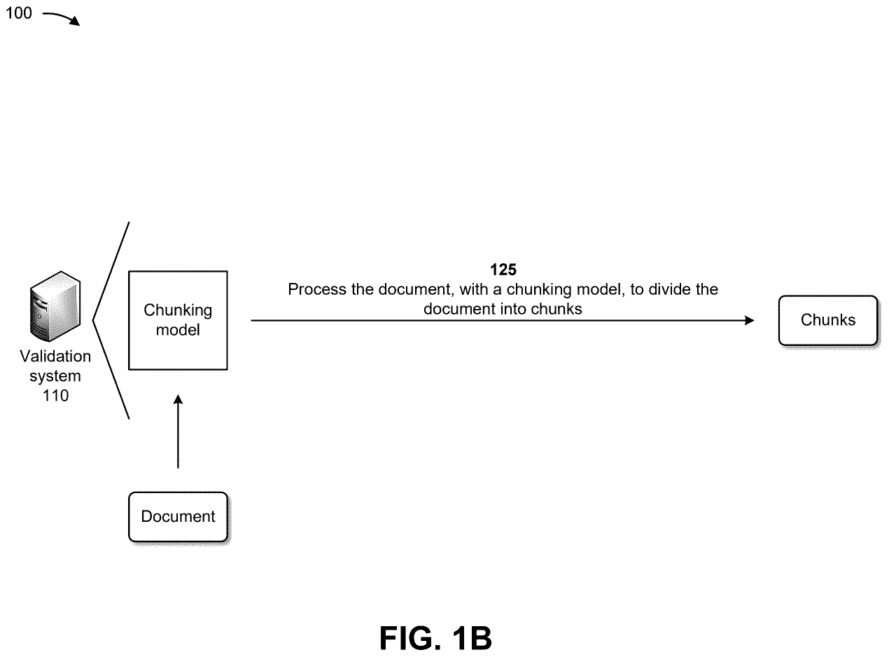

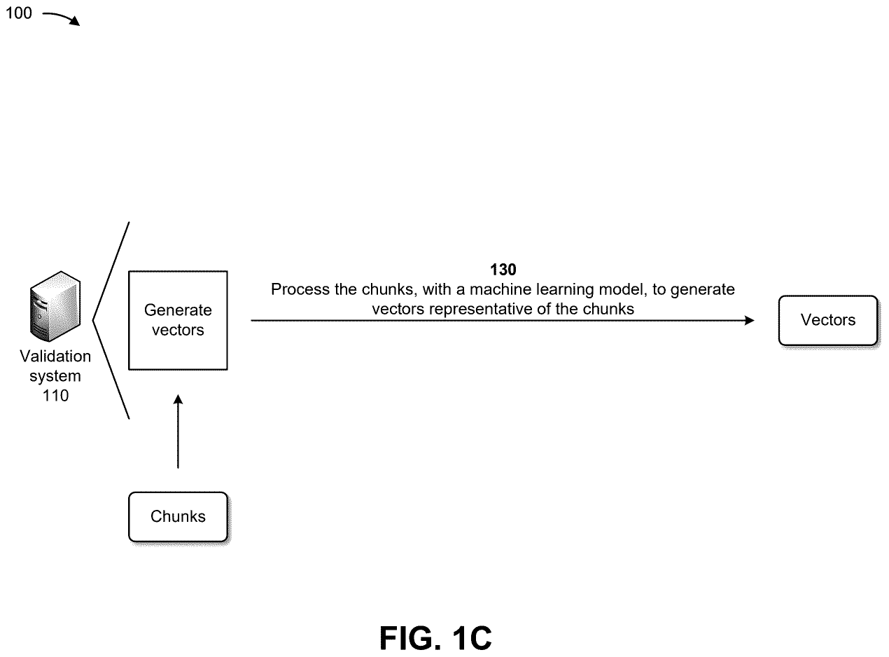

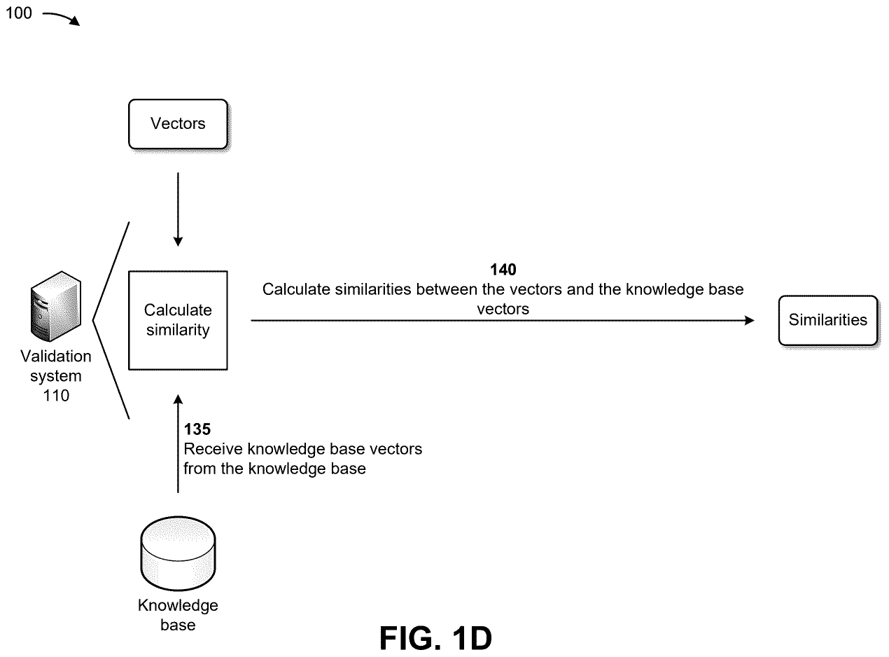

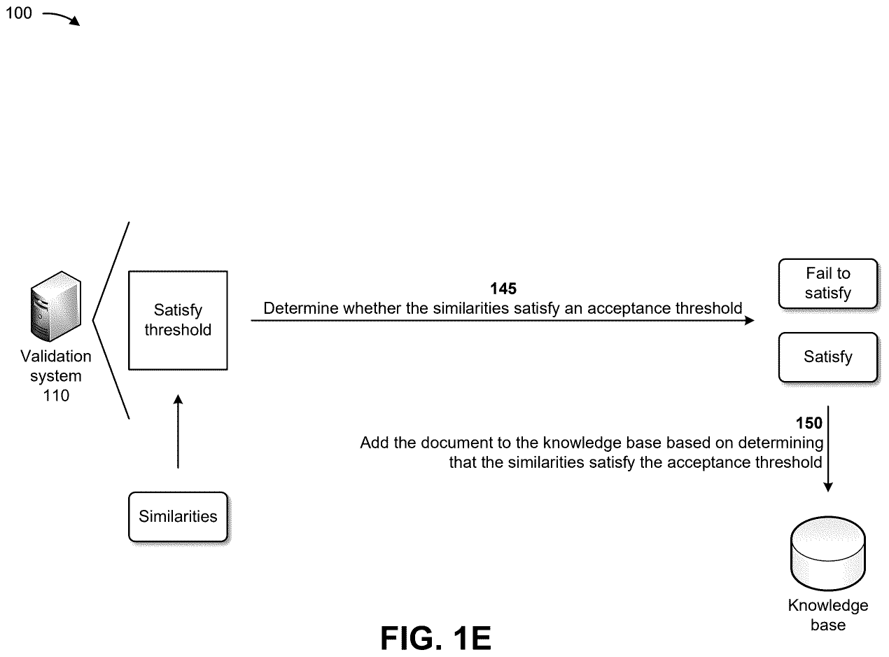

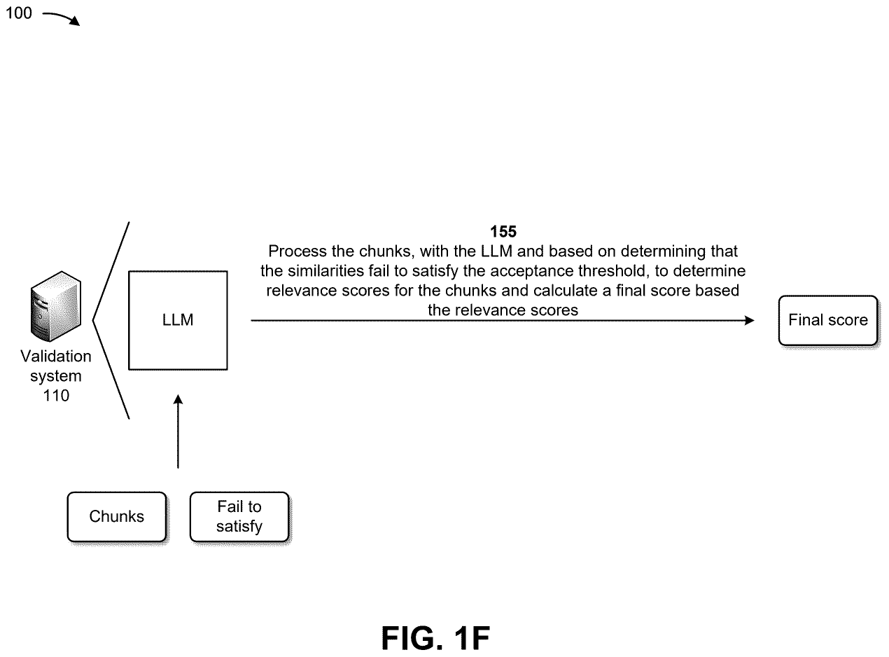

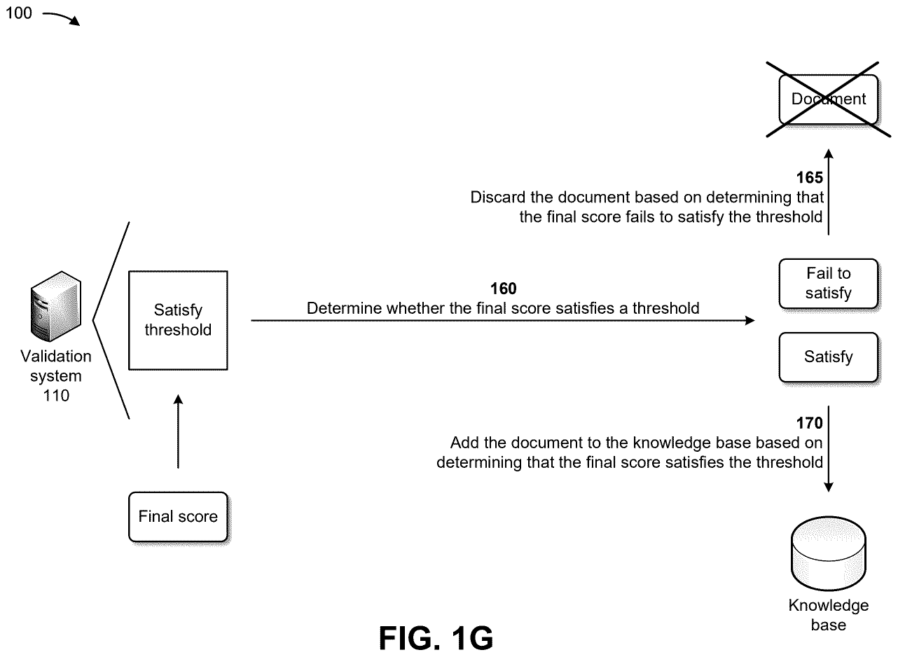

FIGS. 1A-1G are diagrams of an example 100 associated with verifying relevance of information being added to a knowledge base. As shown in FIGS. 1A-1G, the example 100 includes a user device 105 and a knowledge base associated with a validation system 110. The user device 105 may provide, to the validation system 110, information (e.g., documents, knowledge elements, artifacts, and/or the like) to be potentially stored in the knowledge base. The knowledge base may include a database, a table, a list, and/or the like that stores information to be utilized by a large language model (LLM) and/or a retrieval augmented generation (RAG) system. The validation system 110 may include a system that verifies relevance of information being added to a knowledge base. Further details of the user device 105, the knowledge base, and the validation system 110 are provided elsewhere herein. Although implementations described herein depict a single user device 105, in some implementations, the validation system 110 may be associated with multiple user devices 105.

As shown by FIG. 1A, and by reference number 115, the validation system 110 may receive a document potentially to be added to a knowledge base utilized by an LLM. For example, the validation system 110 may assess information (e.g., knowledge elements, such as documents) to be utilized by a generative AI system. The generative AI system may include an LLM that is trained on a knowledge base. For enterprise applications, the LLM may be provided with additional contextual information that is derived from a knowledge base that is more specific to an enterprise and a domain of the enterprise (e.g., an enterprise knowledge base). The generative AI system may utilize the RAG system to index the knowledge base and store a RAG index on an index store. When the LLM is queried, the RAG index may be queried to identify knowledge elements that are relevant to the query. The knowledge elements may be passed to the LLM for output to be generated.

The RAG indexing approach may utilize a semantic analysis with natural language processing (NLP) techniques. The RAG index may be organized at multiple levels to improve performance and accuracy. A RAG system may include a primary index that indexes all knowledge elements provided in the knowledge base. The RAG system may also include a secondary index that is created from knowledge summaries, and/or the like. This may enable a query engine to efficiently locate all relevant knowledge elements. The accuracy and relevance of an output provided by the LLM depends on the fidelity and relevance of the knowledge base used to generate the output. Since a knowledge base may be updated from multiple sources, the validation system 110 may analyze all knowledge elements presented for inclusion in the knowledge base and may flag any knowledge elements that diverge significantly from an existing body of knowledge in the knowledge base.

In some implementations, the user device 105 may generate a document (e.g., with one or more knowledge elements) to potentially be stored in the knowledge base. The user device 105 may provide the document to the validation system 110, and the validation system 110 may receive the document from the user device 105. In some implementations, the document may include textual information, such as words, sentences, paragraphs, punctuation, images, video, audio, and/or the like. In some implementations, the validation system 110 may receive the document via a user interface upload, a network address (e.g., a uniform resource locator (URL)), or manually entered text.

As further shown in FIG. 1A, and by reference number 120, the validation system 110 may determine a chunk size and overlap for a chunking model. For example, the validation system 110 may utilize a chunking model to divide the document into chunks (e.g., smaller, manageable segments) which can improve processing efficiency by the validation system 110.

In some implementations, the validation system 110 may utilize a token-based chunking model to divide the document into chunks. A token-based chunking model may consider linguistic tokens (e.g., words and/or sub-words) rather than raw characters, and may provide a balanced approach that maintains semantic integrity while ensuring consistent token counts. In some implementations, the chunking model may utilize chunk metrics, such as a chunk size and an overlap. “Chunk size” may refer to a maximum size of a chunk, and “overlap” may refer to a degree to which chunks match each other. In one example, the token-based chunking model may include a recursive character text splitter with a chunk size of “1,500” and an overlap of “100.” In some implementations, the chunk size and overlap may be different for different types of documents and similar and for documents of a similar nature In some implementations, the validation system 110 may employ training and validation methods to determine the chunk size and the overlap for the chunking model. For each domain, the validation system 110 may select a few relevant documents and may separate the documents into a training set and a testing set. For each document, the validation system 110 may define LLM prompts whose responses provide a good indication of how well the LLM has learned from the document. For a first document in the training set, the validation system 110 may determine an arbitrary chunk size and overlap, and may embed the document with the chunk size and overlap, may execute the LLM prompts and validate a response to each prompt, and may tune the chunk size and the overlap based on a quality of the prompt response. The validation system 110 may repeat these steps with the other documents in the training set and using the chunk metrics determined from a previous document. Once the LLM is able to provide good quality responses on all of the documents of the training set, the validation system 110 may load the documents of the testing set, may divide the documents into chunks based on the chunk metrics, and may validate LLM responses. The validation system 110 may fine-tune the chunk size and/or the overlap, and may repeat the previous steps if the LLM response quality is not acceptable.

As shown in FIG. 1B, and by reference number 125, the validation system 110 may process the document, with a chunking model, to divide the document into chunks. For example, the validation system 110 may utilize the chunking model to divide the document into smaller, manageable segments or chunks. In some implementations, the chunking model may utilize the predefined chunk metrics, such as the chunk size and the overlap, to optimize the chunking process when dividing the document into the chunks. In some implementations, the chunking model may include a token-based chunking model that divides the document into chunks based on linguistic tokens, such as words or sub-words. The linguistic tokens may ensure that the chunks maintain meaningful text segments, which may enhance semantic analysis by the validation system 110. In some implementations, the chunking model may include a fixed-size chunking model that divides the document into uniform chunks, which may be beneficial for certain types of structured text. The fixed-size chunking model may create uniform chunks for documents with predictable structures, like spreadsheets or logs. Additionally, or alternatively, the chunking model may include a semantic chunking model that segments the document based on semantic boundaries (e.g., sentences or paragraphs) to preserve meaning and context. This may ensure that the chunks maintain complete thoughts or sections, which may provide for accurate semantic analysis and contextual integrity.

Additionally, or alternatively, the chunking model may include a hybrid chunking model that combines both token-based and fixed-size approaches to balance semantic integrity and processing efficiency. The hybrid chunking model may provide the benefits of both approaches, and may offer flexibility and efficiency tailored to the document's content. Additionally, or alternatively, the chunking model may include a machine learning model that dynamically adjusts the chunk size and the overlap based on the content and structure of the document. This may provide adaptive chunking that improves efficiency by tailoring chunk size and overlap dynamically according to the nature of the document. Additionally, or alternatively, the chunking model may incorporate domain-specific chunking rules tailored to the type of document being processed, ensuring optimal chunking for various document types. A chunking strategy may vary based on the document type and/or content. For example, if working with plain text documents, a sliding window based approach may work best when a chunk size and overlap are defined. For structured text like code and/or markdowns, semantic markers may be useful (e.g., end of tags, methods, classes etc.). For PDFs or other non-linear documents (e.g., containing tables, graphs, etc.), chunking may be based on the layout, paragraphs, headings, and/or the like. For audio, chunking may be based on speaker turns or time intervals.

As shown in FIG. 1C, and by reference number 130, the validation system 110 may process the chunks, with a machine learning model, to generate vectors representative of the chunks. For example, the validation system 110 may utilize the machine learning model to embed the chunks into a multi-dimensional vector space, and to generate vector representations of the chunks. In some implementations, the machine learning model may be trained to analyze text semantically, ensuring that the generated vectors capture the semantic meaning of the chunks. The validation system 110 may encode the chunks into a multi-dimensional vector space (e.g., represented as an array of floating-point numbers and referred to as embeddings).

In some implementations, the validation system 110 may select a machine learning model to generate the vectors representative of the chunks based on the content of the knowledge base. Large multi-dimensional vectors may be generated from the embedding process. Each element of each vector may correspond to a specific feature or aspect of text in a chunk, as learned by the machine learning model during training. The features may capture complex relationships within the text, such as semantics, syntax, and other linguistic patterns, which allow the machine learning model to represent text meaningfully in a numerical format. The machine learning model may include, for example, BERT, GPT, etc. for text data, convolutional neural networks (CNNs) for images, Wav2Vec for audio, complex and hybrid models to generate vector embeddings, and/or the like.

In some implementations, processing the chunks with the machine learning model may include the validation system 110 utilizing a neural network model to transform the chunks into the vector representations within the multi-dimensional space. For example, a neural network model may be trained to learn complex patterns within text data, effectively transforming the chunks into rich vector representations that reflect nuances of the embedded text. Additionally, or alternatively, processing the chunks with a machine learning model may include the validation system 110 utilizing a deep learning model to encode the chunks into multi-dimensional vectors. A deep learning model, such as a model based on neural networks, may capture intricate features and relationships within the text, making the deep learning model particularly suitable for generating vectors that preserve the semantic and contextual information of the chunks.

As shown in FIG. 1D, and by reference number 135, the validation system 110 may receive knowledge base vectors from the knowledge base. For example, the validation system 110 may retrieve existing vector representations (e.g., the knowledge base vectors) of existing knowledge elements stored in the knowledge base. The existing knowledge base vectors may represent content already embedded in the knowledge base, and may be utilized by the validation system 110 for a comparison with vectors generated based on new documents.

As further shown in FIG. 1D, and by reference number 140, the validation system 110 may calculate similarities between the vectors and the knowledge base vectors. For example, the validation system 110 may compare the vectors created from the chunks and the knowledge base vectors for similarity using a mathematical method, such as a cosine similarity. Cosine similarity may measure an angle between two vectors in a multi-dimensional space. If the vectors are more similar (e.g., the vectors point in the same direction), then a cosine score may be closer to one (1) (e.g., similar). If the vectors diverge (e.g., point in opposite directions), then the cosine score may be closer to negative one (−1) (e.g., dissimilar). In some implementations, the validation system 110 may determine that one or more of the vectors are similar to one or more of the knowledge base vectors based on the cosine similarity scores. Alternatively, the validation system 110 may determine that one or more of the vectors are dissimilar to one or more of the knowledge base vectors based on the cosine similarity scores. The validation system 110 may utilize the calculated similarities to determine whether the document is relevant and can be added to the knowledge base.

As shown in FIG. 1E, and by reference number 145, the validation system 110 may determine whether the similarities satisfy an acceptance threshold. For example, the validation system 110 may establish an acceptance threshold for cosine similarity scores indicating that one or more of the vectors are similar to one or more of the knowledge base vectors. In some implementations, the validation system 110 may determine the acceptance threshold based on a chunk relevance metric and a document relevance metric. The chunk relevance metric may provide a measure of how much a chunk matches one or more existing knowledge elements in the knowledge base to indicate that the chunk is relevant to the knowledge base. The document relevance metric may provide a measure of how many chunks, associated with similarities that satisfy the acceptance threshold, are required to indicate that the document is relevant to the knowledge base. In some implementations, the validation system 110 may derive the chunk relevance metric and the document relevance metric based on training and testing sets, and may tune the chunk relevance metric and the document relevance metric based on a document type, domain type, document usage, and/or the like.

In some implementations, the validation system 110 may determine that the similarities satisfy the acceptance threshold. This may indicate that the document is to be added to the knowledge base. Alternatively, the validation system 110 may determine that the similarities fail to satisfy the acceptance threshold. This may indicate that the document is not to be added to the knowledge base, and is to be discarded. In such implementations, the validation system 110 may generate a message indicating that the document has been discarded and not stored in the knowledge base, and may provide the message to the user device 105. The user device 105 may display the message to the user so that the user is informed of the unsuccessful storage of the document in the knowledge base.

As further shown in FIG. 1E, and by reference number 150, the validation system 110 may add the document to the knowledge base based on determining that the similarities satisfy the acceptance threshold. For example, when the similarities satisfy the acceptance threshold, the validation system 110 may add the document to the knowledge base. The validation system 110 may provide the document and/or the vectors generated for the chunks of the document to the knowledge base, and the knowledge base may store the document and/or the vectors generated for the chunks of the document. In some implementations, the validation system 110 may generate a message indicating that the document is successfully stored in the knowledge base, and may provide the message to the user device 105. The user device 105 may display the message to the user so that the user is informed of the successful storage of the document in the knowledge base.

As shown in FIG. 1F, and by reference number 155, the validation system 110 may process the chunks, with the LLM and based on determining that the similarities fail to satisfy the acceptance threshold, to determine relevance scores for the chunks and may calculate a final score based on the relevance scores. For example, when the similarities fail to satisfy the acceptance threshold, the validation system 110 may optionally validate whether the document is relevant to the knowledge base before discarding the document. In some implementations, one or more chunks may be semantically somewhat similar to one or more existing knowledge elements in the knowledge base. However, the similarities associated with the one or more chunks may fail to satisfy the acceptance threshold. In such implementations, the validation system 110 may utilize the LLM to validate the one or more chunks and identify which existing knowledge elements of the knowledge base are dissimilar from the one or more chunks. This may enable the validation system 110 to evaluate whether the one or more chunks should be stored in the knowledge base.

The validation system 110 may provide a retrieval context from the knowledge base to the LLM, and may provide the one or more chunks to the LLM with a request to calculate relevance scores for the one or more chunks. The lower a relevance score, the less relevant a chunk is to the knowledge base, and the higher a relevance score, the more relevant a chunk is to the knowledge base. In some implementations, the validation system 110 may calculate a final score for the document based on the relevance scores calculated for the one or more chunks. For example, the validation system 110 may calculate an average of the relevance scores of the chunks as the final score for the document.

As shown in FIG. 1G, and by reference number 160, the validation system 110 may determine whether the final score satisfies a threshold. For example, the validation system 110 may then determine whether the final score satisfies a relevance threshold. In some implementations, the validation system 110 may determine that the final score satisfies the relevance threshold. This may indicate that the document is to be added to the knowledge base. Alternatively, the validation system 110 may determine that the final score fails to satisfy the relevance threshold. This may indicate that the document is not to be added to the knowledge base.

In some implementations, the validation system 110 may calculate the cosine similarity scores and the relevance scores for the chunks, and may calculate variance scores based on a percentile match associated with the cosine similarity scores and the relevance scores for the chunks. The validation system 110 may then determine whether the variance scores satisfy a variance threshold. In some implementations, the validation system 110 may determine that the variance scores satisfy the variance threshold. This may indicate that the document is to be added to the knowledge base. Alternatively, the validation system 110 may determine that the variance scores fail to satisfy the variance threshold. This may indicate that the document is not to be added to the knowledge base.

As further shown in FIG. 1G, and by reference number 165, the validation system 110 may discard the document based on determining that the final score fails to satisfy the threshold. For example, when the final score fails to satisfy the threshold, the validation system 110 may discard the document. In some implementations, the validation system 110 may generate a message indicating that the document has been discarded and not stored in the knowledge base, and may provide the message to the user device 105. The user device 105 may display the message to the user so that the user is informed of the unsuccessful storage of the document in the knowledge base.

As further shown in FIG. 1G, and by reference number 170, the validation system 110 may add the document to the knowledge base based on determining that the final score satisfies the threshold. For example, when the final score satisfies the threshold, the validation system 110 may add the document to the knowledge base. The validation system 110 may provide the document and/or the vectors generated for the chunks of the document to the knowledge base, and the knowledge base may store the document and/or the vectors generated for the chunks of the document. In some implementations, the validation system 110 may generate a message indicating that the document is successfully stored in the knowledge base, and may provide the message to the user device 105. The user device 105 may display the message to the user so that the user is informed of the successful storage of the document in the knowledge base. In some implementations, the LLM may utilize the document stored in the knowledge base to respond to prompts provided to the LLM.

In some implementations, the validation system 110 may track changes in the knowledge base. For example, the validation system 110 may utilize the LLM to identify changes introduced in the knowledge base. The identification of the changes to the knowledge base may utilized for summarization and notification purposes. For example, the LLM may be prompted to prepare a change summary for the knowledge base. The change summary may track changes made to the knowledge base and may provide a quick overview of changes in an operating environment that the knowledge base represents.

In some implementations, the validation system 110 may periodically clean the knowledge base of irrelevant information. For example, in cases where a new document is determined to be irrelevant by the validation system 110, a user may still decide to do a manual override and store the document in the knowledge base. However, due to such manual overrides, there may be cases where the knowledge base gets polluted with irrelevant documents and the LLM responses become degraded. In such scenarios, the validation system 110 may store chunk identifiers and the calculated scores for the chunks in the knowledge base. The validation system 110 may periodically clean the knowledge base with the help of the chunk identifiers and the calculated scores, which may improve the quality of the LLM responses.

In this way, the validation system 110 verifies relevance of information being added to a knowledge base. For example, the validation system 110 may receive a document potentially to be added to a knowledge base utilized by an LLM, and may process the document, with a chunking model, to divide the document into chunks. The validation system 110 may process the chunks, with a machine learning model, to generate vectors representative of the chunks, and may receive knowledge base vectors from the knowledge base. The validation system 110 may calculate similarities between the vectors and the knowledge base vectors, and may determine whether the similarities satisfy an acceptance threshold. The validation system 110 may add the document to the knowledge base based on determining that the similarities satisfy the acceptance threshold, or may process the chunks, with the LLM and based on determining that the similarities fail to satisfy the acceptance threshold, to determine relevance scores for the chunks. The validation system 110 may calculate a final score based on the relevance scores, and may determine whether the final score satisfies a threshold. The validation system 110 may discard the document based on determining that the final score fails to satisfy the threshold, or may add the document to the knowledge base based on determining that the final score satisfies the threshold.

Thus, the validation system 110 may conserve computing resources, networking resources, and/or other resources that would have otherwise been consumed by failing to ensure that the knowledge base remains accurate and free from contamination by irrelevant or incorrect information, generating incorrect LLM responses based on a corrupted knowledge base, making incorrect decisions within the enterprise context based on the incorrect LLM responses, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

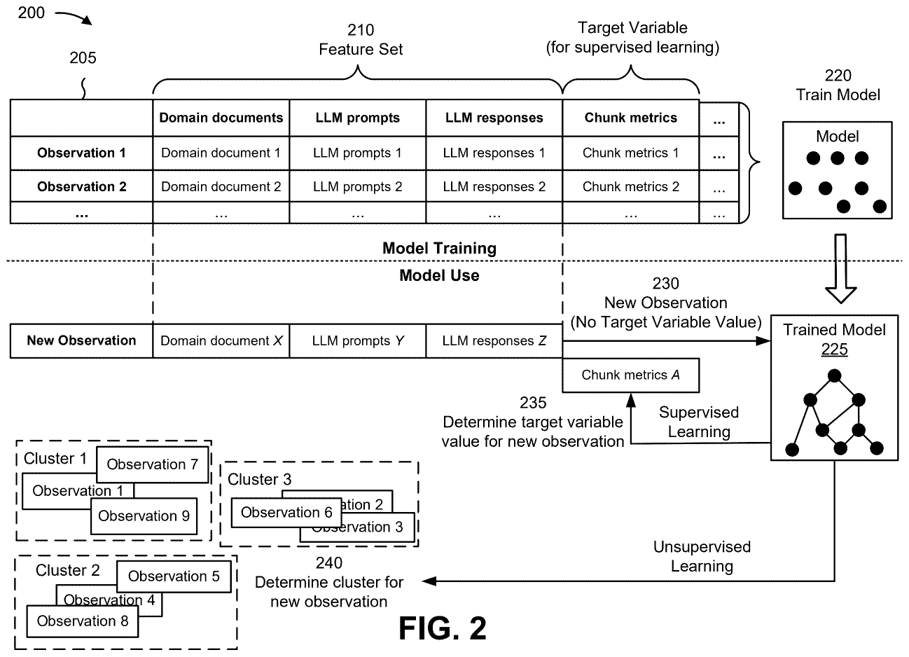

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the validation system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the validation system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the validation system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of domain documents, a second feature of LLM prompts, a third feature of LLM responses, and so on. As shown, for a first observation, the first feature may have a value of domain document 1, the second feature may have a value of LLM prompts 1, the third feature may have a value of LLM responses 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “chunk metrics” and may include a value of chunk metrics 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of domain document X, a second feature of LLM prompts Y, a third feature of LLM responses Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of chunk metrics A for the target variable of the chunk metrics for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a domain document cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., an LLM prompts cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to verify relevance of information being added to a knowledge base. The machine learning system enables recognition and/or identification of tens, hundreds, thousands, or millions of features and/or feature values for tens, hundreds, thousands, or millions of observations, thereby increasing accuracy and consistency and reducing delay associated with verifying relevance of information being added to a knowledge base relative to requiring computing resources to be allocated for tens, hundreds, or thousands of operators to manually verify relevance of information being added to a knowledge base.

As indicated above, FIG. 2 is provided as an example. Other examples may differ from what is described in connection with FIG. 2.

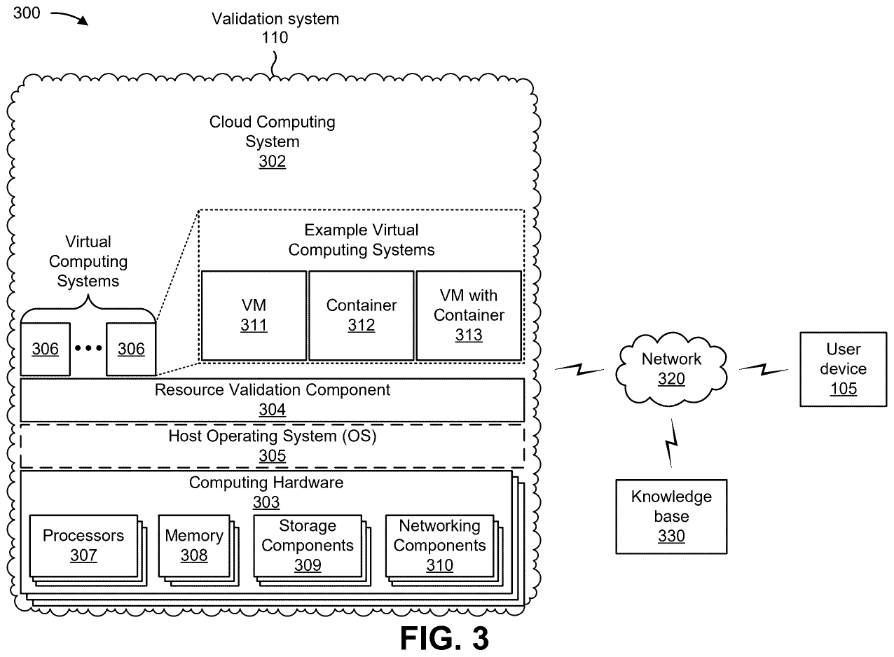

FIG. 3 is a diagram of an example environment 300 in which systems and/or methods described herein may be implemented. As shown in FIG. 3, the environment 300 may include the validation system 110, which may include one or more elements of and/or may execute within a cloud computing system 302. The cloud computing system 302 may include one or more elements 303-313, as described in more detail below. As further shown in FIG. 3, the environment 300 may include a user device 105, a network 320, and/or a knowledge base 330. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, a Snowflake platform, a cloud provider that offers services described herein, and/or the like. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

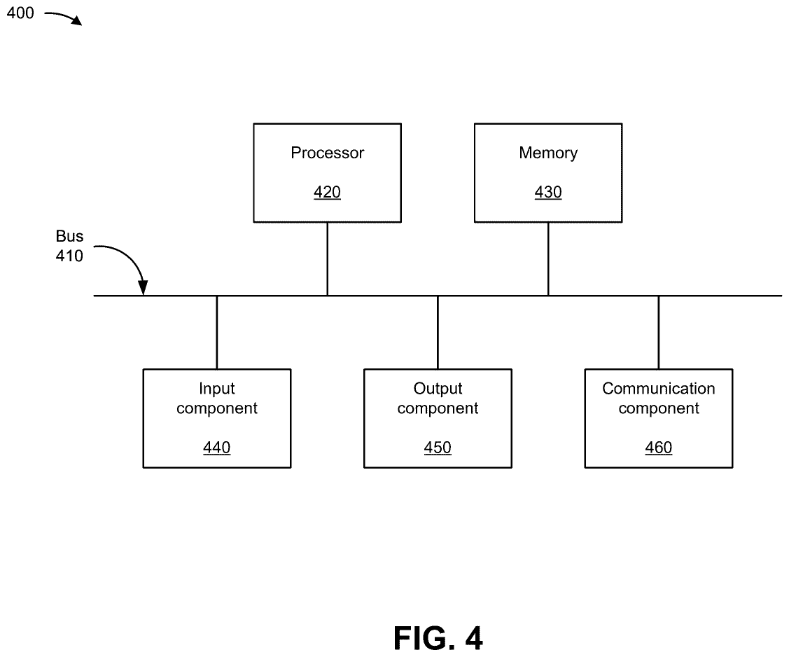

Although the validation system 110 may include one or more elements 303-313 of the cloud computing system 302, may execute within the cloud computing system 302, and/or may be hosted within the cloud computing system 302, in some implementations, the validation system 110 may not be cloud-based (e.g., may be implemented outside of a cloud computing system) or may be partially cloud-based. For example, the validation system 110 may include one or more devices that are not part of the cloud computing system 302, such as a device 400 of FIG. 4, which may include a standalone server or another type of computing device. The validation system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The knowledge base 330 may include one or more devices capable of receiving, generating, storing, processing, and/or providing information, as described elsewhere herein. The knowledge base 330 may include a communication device and/or a computing device. For example, the knowledge base 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The knowledge base 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105, the validation system 110, and/or the knowledge base 330. In some implementations, the user device 105, the validation system 110, and/or the knowledge base 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

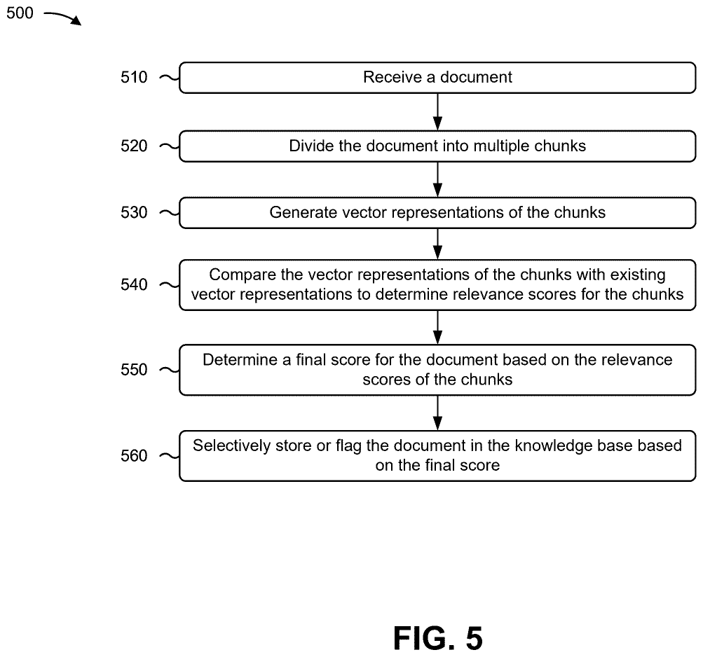

FIG. 5 depicts a flowchart of an example process 500 for verifying relevance of information being added to a knowledge base. In some implementations, one or more process blocks of FIG. 5 may be performed by a device (e.g., the validation system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a document (block 510). For example, the device may receive a document, as described above. In some implementations, the document includes textual information.

As further shown in FIG. 5, process 500 may include dividing the document into multiple chunks (block 520). For example, the device may divide the document into multiple chunks using a chunking model, as described above. In some implementations, dividing the document into the multiple chunks using the chunking model includes utilizing a token-based chunking model with a predefined chunk size and overlap to divide the document into the multiple chunks.

As further shown in FIG. 5, process 500 may include generating vector representations of the chunks (block 530). For example, the device may embed the chunks into a multi-dimensional vector space to generate vector representations of the chunks, as described above. In some implementations, embedding the chunks into the multi-dimensional vector space to generate the vector representations of the chunks includes utilizing a machine learning model, trained to analyze text semantically, to generate the vector representations of the chunks. In some implementations, embedding the chunks into the multi-dimensional vector space to generate the vector representations of the chunks includes selecting a machine learning model for embedding the chunks into the multi-dimensional vector space based on content of the knowledge base.

As further shown in FIG. 5, process 500 may include comparing the vector representations of the chunks with existing vector representations to determine relevance scores for the chunks (block 540). For example, the device may compare the vector representations of the chunks with existing vector representations of existing knowledge elements in a knowledge base using cosine similarity to determine relevance scores for the chunks, as described above. In some implementations, comparing the vector representations of the chunks with the existing vector representations in the knowledge base includes calculating cosine similarity scores between the vector representations of the chunks and the existing vector representations in the knowledge base. In some implementations, the knowledge base is part of a generative artificial intelligence system.

As further shown in FIG. 5, process 500 may include determining a final score for the document based on the relevance scores of the chunks (block 550). For example, the device may determine a final score for the document based on the relevance scores of the chunks, as described above. In some implementations, determining the final score for the document based on the relevance scores of the chunks includes calculating an average of the relevance scores of the chunks as the final score for the document.

As further shown in FIG. 5, process 500 may include selectively storing of flagging the document in the knowledge base based on the final score (block 560). For example, the device may selectively store the document in the knowledge base based on the final score satisfying a threshold, or flag the document for review based on the final score failing to satisfy the threshold, as described above.

In some implementations, process 500 includes defining the threshold based on a chunk relevance metric and a document relevance metric. In some implementations, process 500 includes utilizing, based on the final score failing to satisfy the threshold, a large language model (LLM) to validate the chunks and identify deviations from the existing knowledge elements in the knowledge base. In some implementations, utilizing the LLM to validate the chunks includes providing a retrieval context from the existing knowledge elements in the knowledge base to the LLM, providing the chunks to the LLM, and receiving, from the LLM, additional relevance scores for the chunks.

In some implementations, process 500 includes providing, based on the final score failing to satisfy the threshold, the document for display to enable manual review of the document for addition to the knowledge base. In some implementations, process 500 includes removing irrelevant or malicious knowledge elements from the knowledge base using the document and based on the final score failing to satisfy the threshold.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, by a device, a document, wherein the device comprises one or more machine learning models;
dividing, by the device, the document into multiple chunks using a chunking model, from the one or more machine learning models of the device, wherein the chunking model is configured to dynamically adjust chunk size and overlap based on content and structure of the document;
embedding, by the device, using a neural network model, from the one or more machine learning models of the device, the chunks into a multi-dimensional vector space to generate vector representations of the chunks;
comparing, by the device, the vector representations of the chunks with existing vector representations of existing knowledge elements in a knowledge base for a large language model (LLM) using cosine similarity to determine relevance scores for the chunks, wherein the relevance scores indicate how relevant each of the chunks is to the knowledge base;
determining, by the device, a final score for the document based on the relevance scores of the chunks; and
selectively:
storing, by the device, the document in the knowledge base based on the final score satisfying a threshold, or
flagging, by the device, the document for review based on the final score failing to satisfy the threshold.

2. The method of claim 1, further comprising:
defining the threshold based on a chunk relevance metric and a document relevance metric.

3. The method of claim 1, wherein dividing the document into the multiple chunks using the chunking model comprises:
utilizing a token-based chunking model with a predefined chunk size and overlap to divide the document into the multiple chunks.

4. The method of claim 1, wherein
the neural network model is trained to learn complex patterns within text data, to generate the vector representations of the chunks, and
wherein the vector representations of the chunks are rich vector representations.

5. The method of claim 1, wherein comparing the vector representations of the chunks with the existing vector representations in the knowledge base comprises:
calculating cosine similarity scores between the vector representations of the chunks and the existing vector representations in the knowledge base.

6. The method of claim 1, further comprising:
utilizing, based on the final score failing to satisfy the threshold, the LLM to validate the chunks and identify deviations from the existing knowledge elements in the knowledge base.

7. The method of claim 6, wherein utilizing the LLM to validate the chunks comprises:
providing a retrieval context from the existing knowledge elements in the knowledge base to the LLM;
providing the chunks to the LLM; and
receiving, from the LLM, additional relevance scores for the chunks.

8. A device, comprising:
one or more machine learning models; and
one or more processors configured to:
receive a document;
divide the document into multiple chunks using a chunking model, from the one or more machine learning models, wherein the chunking model is configured to dynamically adjust chunk size and overlap based on content and structure of the document;
embed, using at least one machine learning model, from the one or more machine learning models, the chunks into a multi-dimensional vector space to generate vector representations of the chunks;
compare the vector representations of the chunks with existing vector representations of existing knowledge elements in a knowledge base using cosine similarity to determine relevance scores for the chunks, wherein the relevance scores indicate how relevant each of the chunks is to the knowledge base;
determine a final score for the document based on the relevance scores of the chunks; and
selectively:
store the document in the knowledge base based on the final score satisfying a threshold determined based on a chunk relevance metric and a document relevance metric, or
flag the document for review based on the final score failing to satisfy the threshold.

9. The device of claim 8, wherein the one or more processors, to determine the final score for the document based on the relevance scores of the chunks, are configured to:
calculate a percentile match of the relevance scores of the chunks as the final score for the document.

10. The device of claim 8, wherein the one or more processors are further configured to:
provide, based on the final score failing to satisfy the threshold, the document for display to enable manual review of the document for addition to the knowledge base.

11. The device of claim 8, wherein the document includes textual information.

12. The device of claim 8, wherein the knowledge base is part of a generative artificial intelligence system.

13. The device of claim 8, wherein the one or more processors are further configured to:
remove irrelevant or malicious knowledge elements from the knowledge base using the document and based on the final score failing to satisfy the threshold.

14. The device of claim 8, wherein the one or more processors, to embed the chunks into the multi-dimensional vector space to generate the vector representations of the chunks, are configured to:
select the at least one machine learning model for embedding the chunks into the multi-dimensional vector space based on content of the knowledge base.

15. A non-transitory computer-readable medium storing a set of instructions, the set of instructions comprising:
one or more instructions that, when executed by one or more processors of a device comprising one or more machine learning models, cause the device to:
receive a document that includes textual information;
divide the document into multiple chunks using a chunking model, from the one or more machine learning models of the device, wherein the chunking model is configured to dynamically adjust chunk size and overlap based on content and structure of the document;
embed, using at least one machine learning model, from the one or more machine learning models, the chunks into a multi-dimensional vector space to generate vector representations of the chunks;
compare the vector representations of the chunks with existing vector representations of existing knowledge elements in a knowledge base using cosine similarity to determine relevance scores for the chunks, wherein the relevance scores indicate how relevant each of the chunks is to the knowledge base;
determine a final score for the document based on the relevance scores of the chunks; and
selectively:
store the document in the knowledge base based on the final score satisfying a threshold, or
flag the document for review based on the final score failing to satisfy the threshold.

16. The non-transitory computer-readable medium of claim 15, wherein the one or more instructions, that cause the device to divide the document into the multiple chunks using the chunking model, cause the device to:
utilize a token-based chunking model with a predefined chunk size and overlap to divide the document into the multiple chunks.

17. The non-transitory computer-readable medium of claim 15, wherein the
at least one machine learning model is trained to analyze text semantically, to generate the vector representations of the chunks.

18. The non-transitory computer-readable medium of claim 15, wherein the one or more instructions, that cause the device to compare the vector representations of the chunks with the existing vector representations in the knowledge base, cause the device to:
calculate cosine similarity scores between the vector representations of the chunks and the existing vector representations in the knowledge base.

19. The non-transitory computer-readable medium of claim 15, wherein the one or more instructions further cause the device to:
utilize, based on the final score failing to satisfy the threshold, a large language model (LLM) to validate the chunks and identify deviations from the existing knowledge elements in the knowledge base.

20. The non-transitory computer-readable medium of claim 15, wherein the one or more instructions, that cause the device to determine the final score for the document based on the relevance scores of the chunks, cause the device to:
calculate a percentile match of the relevance scores of the chunks as the final score for the document.
